(19) United States
(12) Patent Application Publication
(10) Pub. No.: US 2025/0254576 A1
(43) Pub. Date: Aug. 7, 2025

(54) ACCESS TO ENERGY SAVING NETWORK

(71) Applicant: Lenovo (Beijing) Limited, Beijing (CN)

(72) Inventors: Ran Yue, Beijing (CN); Lianhai Wu, Beijing (CN); Haiming Wang, Beijing (CN); Zhi Yan, Beijing (CN); Hongmei Liu, Beijing (CN); Yingying Li, Beijing (CN)

(73) Assignee: Lenovo (Beijing) Limited, Beijing (CN)

(21) Appl. No.: 18/855,196

(22) PCT Filed: May 10, 2022
(86) PCT No.: PCT/CN2022/091971

§ 371 Date: Oct. 8, 2024

(51) Int. Cl. H04W 36/00; H04W 36/08

(52) U.S. Cl. CPC H04W 36/008357; H04W 36/0058; H04W 36/08

(57) ABSTRACT

Methods and apparatuses for new cell selection and re-selection are disclosed. A user equipment (UE) comprises a processor; and a transceiver coupled to the processor, wherein, the processor is configured to identify new cells that implement network energy saving techniques; and select or re-select a new cell that fulfills a predetermined criterion, when cell selection or re-selection is performed.

### FIELD

The subject matter disclosed herein generally relates to wireless communications, and more particularly relates to methods and apparatuses for access to an energy saving network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Reference Signal Receiving Power (RSRP), Reference Signal Receiving Quality (RSRQ), Radio Access Technology (RAT), Master information block (MIB), System Information Block (SIB), non-access-stratum (NAS), Ultra-reliable Low-latency Communication (URLLC).

When a UE attempts to camp on a network, the UE searches candidate cells on at least one frequency. When a cell fulfills cell selection criterion S, the cell can be selected. The cell selection criterion S is fulfilled when Srxlev>0 and Squal>0, where Srxlev is cell selection RX level value in unit of dB, and Squal is cell selection quality value in unit of dB. Srxlev is related to reference signal receiving power (RSRP), and Squal is related to reference signal receiving quality (RSRQ).

When a UE camps on a cell (serving cell), it may perform cell re-selection when certain criterion fulfills. It means that the UE attempts to find another cell to camp on, e.g. when the quality of the other cell is better than that of the serving cell.

A UE that supports the feature of network energy saving techniques may be referred to as new UE. A UE that does not support the feature of network energy saving techniques may be referred to as legacy UE. A base unit that supports the feature of network energy saving techniques may be referred to as new base unit. A base unit that does not support the feature of network energy saving techniques may be referred to as legacy base unit. A base unit can be represented by a gNB or a cell. That is, new base unit can be represented by new cell.

From the viewpoint of network energy saving, it is preferable that a new UE camps on a new cell.

However, in the prior art, there is no disclosure on how to identify the new cell and the legacy cell. In addition, when the UE performs cell selection or cell re-selection, no criterion is related to selecting a new cell.

This invention targets new cell selection and re-selection.

### BRIEF SUMMARY

Methods and apparatuses for new cell selection and re-selection are disclosed.

In one embodiment, a UE comprises a processor; and a transceiver coupled to the processor, wherein, the processor is configured to identify new cells that implement network energy saving techniques; and select or re-select a new cell that fulfills a predetermined criterion, when cell selection or re-selection is performed.

In one embodiment, the processor is configured to receive, via the transceiver, system information broadcast or dedicated signaling to identify new cells. In some embodiment, the new cell has precedence over the legacy cell that does not implement network energy saving techniques in cell selection or re-selection.

In another embodiment, the processor is further configured to identify whether a new cell is a new cell in sleep state or a new cell in non-sleep state. In particular, the processor is configured to receive, via the transceiver, system information broadcast or dedicated signaling to identify the state of the new cell. In some embodiment, the new cell in sleep state has precedence over the new cell in non-sleep state in cell selection or re-selection. In some other embodiment, the new cell in non-sleep state has precedence over the new cell in sleep state in cell selection or re-selection.

In some embodiment, cell re-selection is performed in response the serving cell of the UE being not a new cell.

In another embodiment, a method performed by a UE comprises identifying new cells that implement network energy saving techniques; and selecting or re-select a new cell that fulfills a predetermined criterion, when cell selection or re-selection is performed.

In yet another embodiment, a base unit comprises a processor; and a transceiver coupled to the processor, wherein, the processor is configured to indicate, via the transceiver, whether the base unit is a new base unit that implements network energy saving techniques.

In some embodiment, the processor is further configured to indicate, via the transceiver, whether each of neighboring base units is a new base unit that implements network energy saving techniques.

In still another embodiment, a method performed by a base unit comprises indicating whether the base unit is a new base unit that implements network energy saving techniques.

In some embodiment, the processor is further configured to indicate, via the transceiver, whether the base unit is a new base unit in sleep state or a new base unit in non-sleep state. In particular, the processor is further configured to indicate whether each of neighboring base units is a new base unit in sleep state or a new base unit in non-sleep state.

In some embodiment, the processor is configured to transmit, via the transceiver, system information broadcast or dedicated signaling to indicate whether the base unit is the new base unit.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example scenario of new cell involved in cell selection or re-selection;

FIG. 2 illustrates an example scenario of new cell in sleep state and new cell in non-sleep state involved in cell selection or re-selection;

FIG. 3 is a schematic flow chart diagram illustrating an embodiment of a method;

FIG. 4 is a schematic flow chart diagram illustrating a further embodiment of a method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

A UE camps on a cell (i.e. serving cell). It means that the UE can receive system information broadcasted by the gNB of the cell. Accordingly, a cell can be represented by a gNB. In other words, new cell can be represented by new gNB (or new gNB/cell) or new base unit; while legacy cell can be represented by legacy gNB (or legacy gNB/cell) or legacy base unit.

A gNB/cell can be searched by its frequency. It means that the gNB/cell can be identified by its frequency. Each gNB/cell can only operate in a specific frequency. Different gNBs/cells may operate in different frequencies. When a UE camping on a serving gNB/cell performs gNB/cell re-selection, if the UE can identify priority of the frequencies on which gNBs/cells operate (e.g. according to priority provided in system information, or provided in dedicated signaling), the candidate gNBs/cells can be classified as gNBs/cells on a higher priority frequency, gNBs/cells on an equal priority frequency, and gNBs/cells on a lower priority frequency.

For clarification, in the following description, if appropriate, new cell is used to represent new gNB, or new gNB/cell, or new base unit; and legacy cell is used to represent legacy gNB, or legacy gNB/cell, or legacy gNB/cell.

A new cell and a legacy cell can be neighboring cells. It means that the coverage of the new cell and the coverage of the legacy cell may be overlapped, while the UE in the overlapped area of neighboring cells may select either the new cell or the legacy cell.

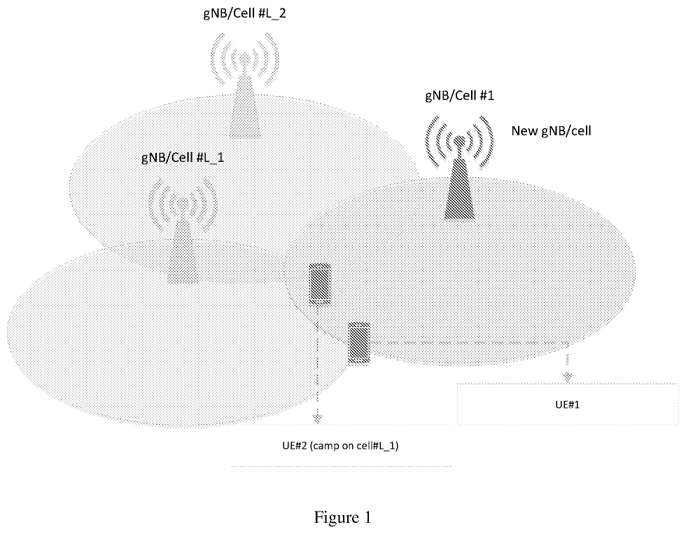

In an example scenario illustrated in FIG. 1, UE #1, which is a new UE, attempts to camp on one of neighboring cells in a network that includes cell #L_1 (which is a legacy cell), cell #L_2 (which is a legacy cell) and cell #1 (which is a new cell). The question is: in which condition the new UE (e.g. UE #1) would select the new cell (e.g. cell #1) to camp on?

In the example scenario illustrated in FIG. 1, UE #2, which is also a new UE and camps on a legacy cell (e.g. cell #L_1), attempts to make cell re-selection. The question is: in which condition the new UE (e.g. UE #2 camping on a legacy cell) would re-select a new cell (e.g. cell #1) to camp on?

The new cell, which supports the feature of network energy saving techniques, may be in non-sleep state (e.g. normal state, active state, etc) or in sleep state. A new gNB/cell is in sleep state means the new gNB/cell is in the state of low energy consumption. There could be multiple sleep states, for example micro sleep state, light sleep state, deep sleep state, etc. Each of the sleep states corresponds to a different level of energy consumption. The different level of energy consumption may be represented by different state transition time, or by different reference parameters or different configurations or different configuration periods, or by different levels of TX power, or by different levels of power consumption, or by different levels of resource allocation, etc. Each of different levels may be less than 100%. A new gNB/cell is in non-sleep state means the new gNB/cell can utilize the full level of energy. Correspondingly, the state transition time, or TX power, or power consumption, or resource allocation, etc in non-sleep state can be 100% or can be higher than the level in sleep state.

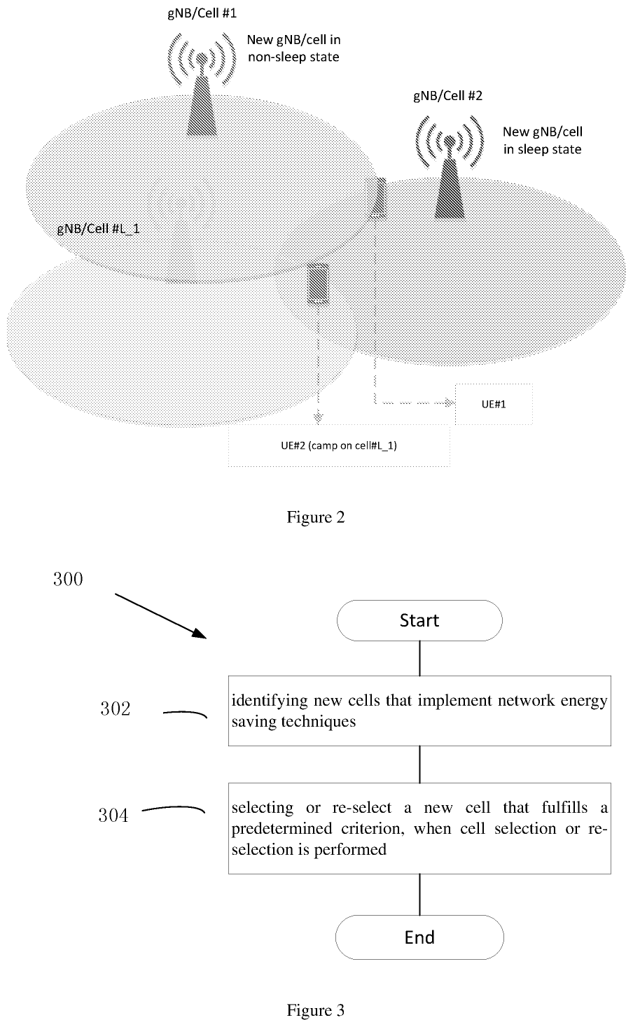

In an example scenario illustrated in FIG. 2, the network includes cell #L_1 (which is a legacy cell), cell #1 (which is a new cell in non-sleep state) and cell #2 (which is a new cell in sleep state). When UE #1 (which is a new UE) makes cell selection or UE #2 (which is a new UE camping on the legacy cell (e.g. cell #L_1) makes cell re-selection, shall the new UE (e.g. UE #1, or UE #2) distinguish the states of the new cells? In particular, if the UE can distinguish a different state (e.g. sleep state or non-sleep state) of the new cell, does the UE have any preference on selecting the new cell in the sleep state and the new cell in the non-sleep state?

This disclosure proposes different solutions related to cell selection or re-selection when new cell(s) are involved.

A first embodiment relates to identifying new cell(s) and identifying the state of a new cell.

A cell, that is a new cell, can be indicated implicitly or explicitly. For example, the indication of the new cell can be made by system information broadcast or by dedicated signaling.

An example of implicit indication can be that the new gNB indicates that some SSB(s) can be off or are off by system information broadcast.

An example of explicit indication can be that the new gNB broadcasts that the gNB is a new gNB in system information broadcast (e.g. in MIB or SIB1 or other SIB). For example, the gNB being a new gNB may be a new feature or a new type of feature in the system information broadcast.

Incidentally, a cell can implicitly or explicitly broadcast, in addition to whether the cell itself is a new cell, whether each of its neighboring cells is a new cell. For example, a serving gNB may indicate, by dedicated signaling, to a UE being released to IDLE state, whether the cell to which the UE is released is a new cell and whether each of the neighboring cells to the cell to which the UE is released is a new cell.

The state of the new cell can be also contained in the system information broadcast (e.g. implicitly indicated when some specific SSBs can be off or are off, or explicitly indicated in MIB or SIB1 or other SIB) or in the dedicated signaling. For example, if some specific SSBs are off, the new cell is implicitly indicated as being in sleep state; and if some other specific SSBs are off, the new cell is implicitly indicated as being in non-sleep state. For another example, a serving gNB may indicate, by dedicated signaling, to a UE being released to IDLE state, whether the cell to which the UE is released is a new cell in sleep state or a new cell in non-sleep state and whether each of the neighboring cells to the cell to which the UE is released is a new cell in sleep state or a new cell in non-sleep state.

Incidentally, a cell can implicitly or explicitly broadcast, in addition to whether the cell itself is a new cell sleep state or a new cell in non-sleep state, whether each of its neighboring cells is a new cell in sleep state or a new cell in non-sleep state.

A second embodiment relates to criteria to be fulfilled (i.e. condition(s) to be met) when a new cell is selected.

Criterion 2_1: the new cell is the strongest cell among all candidate cells. The legacy definition of strongest cell can be reused.

Criterion 2_2: the quality of the new cell is greater than a predetermined threshold (e.g. threshold #2_2).

Criterion 2_3: the new cell fulfills the cell selection criterion S.

Criterion 2_4: the best quality of the other candidate cells (e.g. other candidate legacy cells)—the quality of the new cell is equal to or smaller than a predetermined threshold (e.g. threshold #2_4). For example, if the best quality of the other candidate legacy cells is 10 dB, the quality of the new cell is 7 dB, and the predetermined threshold #2_4 is 4 dB, then the best quality of the other candidate legacy cells—the quality of the new cell is 3 dB that is smaller than the predetermined threshold #2_4 (i.e. 4 dB). Accordingly, the new cell can be selected when criterion 2_4 is fulfilled.

Criterion 2_5: the best quality of the other candidate cells (e.g. other candidate legacy cells)—the quality of the new cell is equal to or smaller than a predetermined threshold (e.g. threshold #2_5) in the condition that all candidate cells (including the new cell) have the same frequency. Criterion 2_5 can be regarded as a special case of Criterion 2_4. That is, Criterion 2_5 is equal to Criterion 2_4 in the condition that all candidate cells (including the new cell) have the same frequency.

Criterion 2_6: the new cell fulfills the cell selection criterion S, and a specific traffic (e.g. any of urgent traffics or pre-defined traffics by the specification or the network, for example URLLC or the traffic with critical requirement on latency) is not included in the UE or is not supported by the UE when the UE performs cell selection. Criterion 2_6 can be regarded as a special case of Criterion 2_3. That is, Criterion 2_6 is equal to Criterion 2_3 plus that any specific traffic is not included or supported when the UE performs cell selection.

For each of Criteria 2_2, 2_3, 2_4, 2_5 and 2_6, if there are multiple new cells fulfilling the criterion, one of the multiple new cells fulfilling the criterion is selected, for example, (1) the strongest cell among the multiple new cells fulfilling the criterion; (2) any new cell (e.g. a randomly selected cell) among the multiple new cells fulfilling the criterion; (3) the first new cell fulfilling the criterion; or (4) up to UE implementation.

The new cell fulfilling any of the above-described Criteria 2_1 to 2_6 can be selected as the serving cell. In addition, it is possible that the new cell fulfilling at least one of the above-described Criteria 2_1 to 2_6 can be selected as the serving cell. For example, it is possible that the new cell fulfilling both Criterion 2_3 and Criterion 2_4 can be selected as the serving cell.

Any or at least one of the above-described Criteria 2_1 to 2_6 is applied if the UE is configured to distinguish new cell(s) and legacy cell(s) when the cell selection is performed. The configuration to distinguish new cell(s) and legacy cell(s) may be by default, e.g. pre-specified. Alternatively, the NAS layer of the UE may indicate to the UE on whether new cell(s) and legacy cell(s) are distinguished when the cell selection is performed.

A third embodiment relates to measurement rules for cell re-selection.

When a UE camps on a cell (serving cell), the UE shall regularly search for a better cell after a predetermined time period (e.g. 1 second). If a better cell is found, the better cell is (re-)selected as the serving cell.

When new cell(s) are involved in cell re-selection, new measurement rules for cell re-selection are proposed.

New measurement rule 3_1: if the serving cell (i.e. the cell on which the UE camps) is not a new cell, the UE (e.g. the new UE) performs measurements for cell re-selection.

New measurement rule 3_2: if the serving cell (i.e. the cell on which the UE camps) is not a new cell and a specific traffic (e.g. any of urgent traffics or pre-defined traffics by the specification or the network, for example URLLC or the traffic with critical requirement on latency) is not included in the UE or is not supported by the UE, the UE (e.g. the new UE) performs measurements for cell re-selection.

New measurement rule 3_3: if the serving cell (i.e. the cell on which the UE camps), which is not a new cell, fulfils Srxlev>S_{IntraSearchP} and/or Squal>S_{IntraSearchQ} (among the cells on the highest priority frequency(ies) for inter-frequency cell re-selection within NR, S_{IntraSearchP} specifies the Srxlev threshold in unit of dB for intra-frequency measurements, and S_{IntraSearchQ} specifies the Squal threshold in unit of dB for intra-frequency measurements, where, Srxlev is the cell selection RX level value in unit of dB, and Squal is cell selection quality value in unit of dB) and/or fulfills Srxlev>S_{nonIntraSearchP} and/or Squal>S_{nonIntraSearchQ} (S_{nonIntraSearchP} specifies the Srxlev threshold in unit of dB for NR inter-frequency and inter-RAT measurements, and S_{nonIntraSearchQ} specifies the Squal threshold in unit of dB for NR inter-frequency and inter-RAT measurements), the UE (e.g. the new UE) performs measurements for cell re-selection.

New measurement rule 3_4: if the serving cell (i.e. the cell on which the UE camps), which is not a new cell, fulfils Srxlev>S_{IntraSearchP} and/or Squal>S_{IntraSearchQ} and/or fulfills Srxlev>S_{nonIntraSearchP} and/or Squal>S_{nonIntraSearchQ}, and a specific traffic (e.g. any of urgent traffics or pre-defined traffics by the specification or the network, for example URLLC or the traffic with critical requirement on latency) is not included in the UE or is not supported by the UE, the UE (e.g. the new UE) performs measurements for cell re-selection.

New measurement rule 3_5: if the serving cell will not be a suitable new cell (e.g. the state of new cell will transit from the non-sleep state to sleep state), the new UE performs measurements for cell re-selection.

New measurement rule 3_6: if the specific traffic (e.g. any of urgent traffics or pre-defined traffics by the specification or the network, for example URLLC or the traffic with critical requirement on latency) is included in the UE or is supported by the UE (which implies that the UE is not suitable to the new cell in sleep state), the new UE (e.g. the new UE camping in a new cell in sleep state, or camping in a new cell in non-sleep state which will transit to sleep state) performs measurements for cell re-selection.

New measurement rule 3_7: if the specific traffic (e.g. any of urgent traffics or pre-defined traffics by the specification or the network, for example URLLC or the traffic with critical requirement on latency) arrives, the new UE (e.g. the new UE camping in a new cell in sleep state, or camping in a new cell in non-sleep state which will transit to sleep state) performs measurements for cell re-selection.

When any of the new measurement rules (e.g. new measurement rules 3_1 to 3_7) is fulfilled, the UE (e.g. the new UE) performs measurements for cell re-selection.

A fourth embodiment relates to criteria to be fulfilled when a new cell is re-selected.

Criterion 4_1: if more than one cell (including new cell(s) and legacy cell(s)) meets the existing cell re-selection criteria, the UE shall re-select a new cell which is the highest ranked new cell or the strongest new cell among the cells on the highest priority frequency (ies) meeting the criteria.

Criterion 4_2: the quality of the new cell is better than that of the serving cell.

Criterion 4_3: the new cell with the best quality among all new cells.

Criterion 4_4: the quality of the new cell is greater than a predetermined threshold (e.g. threshold #4_4).

Criterion 4_5: the quality of the new cell of the highest frequency priority is greater than a predetermined threshold (e.g. threshold #4_5).

Criterion 4_6: the quality of the new cell of the highest frequency priority is greater than a predetermined threshold (e.g. threshold #4_6), and the highest frequency priority is higher than the frequency priority of the serving cell.

Criterion 4_7: the quality of the new cell of the highest frequency priority is greater than a predetermined threshold (e.g. threshold #4_7), and the highest frequency priority is lower than the frequency priority of the serving cell.

Criterion 4_8: the best new cell among the new cells, the quality of each of which is greater than a predetermined threshold (e.g. threshold #4_8). For example, if the RSRP of new cell #1 is 5 dB, the RSRP of new cell #2 is 4 dB, the RSRP of new cell #3 is 2 dB, and threshold #4_8 is 3 dB, then, the new cells, the quality of each of which is greater than 3 dB, are new cell #1 and new cell #2, since the quality of new cell #3 is lower than 3 dB. So, the best new cell among new cell #1 and new cell #2 is new cell #1.

Criterion 4_9: the best new cell among the new cells, the number of good beams (good beam means the measured quality of the beam is higher than a predetermined threshold (e.g. threshold #goodbeam)) of each of which is above a predetermined threshold (e.g. threshold #4_9).

Criterion 4_10: the best quality of the other candidate cells (e.g. other candidate legacy cells)—the quality of the new cell is equal to or smaller than a predetermined threshold (e.g. threshold #4_10).

For each of Criteria 4_2, 4_4, 4_5, 4_6, 4_7 and 4_10, if there are multiple new cells fulfilling the criterion, one of the multiple new cells fulfilling the criterion is selected, for example, (1) the strongest cell among the multiple new cells fulfilling the criterion; (2) any new cell (e.g. a randomly selected cell) among the multiple new cells fulfilling the criterion; (3) the first new cell fulfilling the criterion; or (4) up to UE implementation.

For each of the above-described Criteria 4_1 to 4_10, a new condition can be added: a specific traffic (e.g. any of urgent traffics or pre-defined traffics by the specification or the network, for example URLLC or the traffic with critical requirement on latency) is not included in the UE or is not supported by the UE when the UE performs cell re-selection. In other words, each of Criterion 4_x′ (where x=1 to 10) is equal to Criterion 4_x plus the new condition.

The new cell fulfilling any of the above-described Criteria 4_1 to 4_10 and 4_1′ to 4_10′ can be re-selected as the serving cell. In addition, it is possible that the new cell fulfilling at least one of the above-described Criteria 4_1 to 4_10 and 4_1′ to 4_10′ can be re-selected as the serving cell.

In addition, for each of above described criteria 4_1 to 4_10 and 4_1′ to 4_10′, the new cell fulfilling the criterion may mean that the criterion is fulfilled and maintained during a predetermined time interval (e.g. 1 second).

A fifth embodiment relates to distinguishing sleep state and non-sleep state of the new cell.

According to a first sub-embodiment of the fifth embodiment, the state of the new cell is not considered when cell selection or re-selection is performed. It means that both the new cell in sleep state and the new cell in non-sleep state are considered as new cell without distinction. In particular, if a specific traffic (e.g. any of urgent traffics or pre-defined traffics by the specification or the network, for example URLLC or the traffic with critical requirement on latency) is not included in the UE or is not supported by the UE when the UE performs cell selection or re-selection, both the new cell in sleep state and the new cell in non-sleep state are considered as new cell without distinction.

According to a second sub-embodiment of the fifth embodiment, the new cell in non-sleep state has a preference over the new cell in sleep state. It means that, when cell selection or re-selection is performed, the new cell in sleep state can be (re-) selected only if there is no new cell in non-sleep state fulfilling the criterion (a) (e.g. at least one of Criteria 2_1 to 2_6, or at least one of criteria 4_1 to 4_10 and 4_1′ to 4_10′).

According to a third sub-embodiment of the fifth embodiment, the new cell in sleep state has a preference over the new cell in non-sleep state. It means that, when cell selection or re-selection is performed, the new cell in non-sleep state can be (re-) selected only if there is no new cell in sleep state fulfilling the criterion (a) (e.g. at least one of Criteria 2_1 to 2_6, or at least one of criteria 4_1 to 4_10 and 4_1′ to 4_10′). In particular, the third sub-embodiment of the fifth embodiment applies to specific UEs (e.g. a UE supporting power saving, or a UE with low battery power, or a UE supporting network energy savings).

FIG. 3 is a schematic flow chart diagram illustrating an embodiment of a method 300 according to the present application. In some embodiments, the method 300 is performed by an apparatus, such as a remote unit (UE). In certain embodiments, the method 300 may be performed by a processor executing program code, for example, a microcontroller, a microprocessor, a CPU, a GPU, an auxiliary processing unit, a FPGA, or the like.

The method 300 may be performed by a UE and comprise 302 identifying new cells that implement network energy saving techniques; and 304 selecting or re-select a new cell that fulfills a predetermined criterion, when cell selection or re-selection is performed.

In some embodiment, the method 300 comprises receiving system information broadcast or dedicated signaling to identify new cells. In some embodiment, the new cell has precedence over the legacy cell that does not implement network energy saving techniques in cell selection or re-selection.

In some embodiment, the method 300 further comprises identifying whether a new cell is a new cell in sleep state or a new cell in non-sleep state. In particular, the method 300 comprises receiving system information broadcast or dedicated signaling to identify the state of the new cell. In some embodiment, the new cell in sleep state has precedence over the new cell in non-sleep state in cell selection or re-selection. In some other embodiment, the new cell in non-sleep state has precedence over the new cell in sleep state in cell selection or re-selection.

In some embodiment, cell re-selection is performed in response the serving cell of the UE being not a new cell.

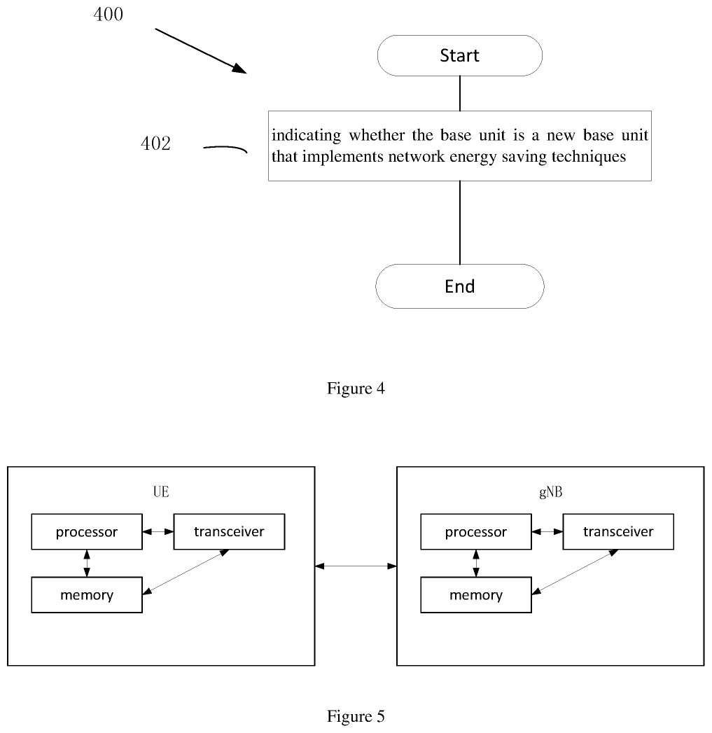

FIG. 4 is a schematic flow chart diagram illustrating a further embodiment of a method 400 according to the present application. In some embodiments, the method 400 is performed by an apparatus, such as a base unit or a network device. In certain embodiments, the method 400 may be performed by a processor executing program code, for example, a microcontroller, a microprocessor, a CPU, a GPU, an auxiliary processing unit, a FPGA, or the like.

The method 400 may be performed by a network device and comprise 402 indicating whether the base unit is a new base unit that implements network energy saving techniques.

In some embodiment, the method 400 further comprises indicating whether each of neighboring base units is a new base unit that implements network energy saving techniques.

In some embodiment, the method 400 further comprises indicating whether the base unit is a new base unit in sleep state or a new base unit in non-sleep state. In some embodiment, the method 400 further comprises indicating whether each of neighboring base units is a new base unit in sleep state or a new base unit in non-sleep state.

In some embodiment, the method 400 comprises transmitting system information broadcast or dedicated signaling to indicate whether the base unit is the new base unit.

FIG. 5 is a schematic block diagram illustrating apparatuses according to one embodiment.

Referring to FIG. 5, the UE (i.e. remote unit, or terminal device) includes a processor, a memory, and a transceiver. The processor implements a function, a process, and/or a method which are proposed in FIG. 3.

The UE comprises a processor; and a transceiver coupled to the processor, wherein, the processor is configured to identify new cells that implement network energy saving techniques; and select or re-select a new cell that fulfills a predetermined criterion, when cell selection or re-selection is performed.

In some embodiment, the processor is configured to receive, via the transceiver, system information broadcast or dedicated signaling to identify new cells. In some embodiment, the new cell has precedence over the legacy cell that does not implement network energy saving techniques in cell selection or re-selection.

In some embodiment, the processor is further configured to identify whether a new cell is a new cell in sleep state or a new cell in non-sleep state. In particular, the processor is configured to receive, via the transceiver, system information broadcast or dedicated signaling to identify the state of the new cell. In some embodiment, the new cell in sleep state has precedence over the new cell in non-sleep state in cell selection or re-selection. In some other embodiment, the new cell in non-sleep state has precedence over the new cell in sleep state in cell selection or re-selection.

In some embodiment, cell re-selection is performed in response the serving cell of the UE being not a new cell.

Referring to FIG. 5, the gNB (i.e. base unit or network device) includes a processor, a memory, and a transceiver. The processor implements a function, a process, and/or a method which are proposed in FIG. 4.

The base unit comprises a processor; and a transceiver coupled to the processor, wherein, the processor is configured to indicate, via the transceiver, whether the base unit is a new base unit that implements network energy saving techniques.

In some embodiment, the processor is further configured to indicate, via the transceiver, whether each of neighboring base units is a new base unit that implements network energy saving techniques.

In some embodiment, the processor is further configured to indicate, via the transceiver, whether the base unit is a new base unit in sleep state or a new base unit in non-sleep state. In particular, the processor is further configured to indicate whether each of neighboring base units is a new base unit in sleep state or a new base unit in non-sleep state.

In some embodiment, the processor is configured to transmit, via the transceiver, system information broadcast or dedicated signaling to indicate whether the base unit is the new base unit.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1. A user equipment (UE), the UE comprising:
at least one memory; and
at least one processor coupled with the at least one memory and configured to cause the UE to:
identify cells that implement at least one network energy saving technique; and
select or re-select a cell that implements at least one network energy saving technique and that fulfills a predetermined criterion based at least in part on cell selection or re-selection being performed.

2. The UE of claim 1, wherein, the at least one processor is configured to cause the UE to receive system information broadcast or dedicated signaling to identify cells that implement at least one network energy saving technique.

3. The UE of claim 1, wherein, the cell that implements at least one network energy saving technique has precedence over a legacy cell that does not implement at least one network energy saving technique in cell selection or re-selection.

4. The UE of claim 1, wherein, the at least one processor is configured to cause the UE to identify whether a cell that implements at least one network energy saving technique is in sleep state or in non-sleep state.

5. The UE of claim 4, wherein, the at least one processor is configured to cause the UE to receive system information broadcast or dedicated signaling to identify the state of the cell that implements at least one network energy saving technique.

6. The UE of claim 4, wherein, a cell that implements at least one network energy saving technique in sleep state has precedence over a cell that implements at least one network energy saving technique in non-sleep state in cell selection or re-selection.

7. The UE of claim 4, wherein, a cell that implements at least one network energy saving technique in non-sleep state has precedence over a cell that implements at least one network energy saving technique in sleep state in cell selection or re-selection.

8. The UE of claim 1, wherein, in response a serving cell of the UE being not a cell that implements at least one network energy saving technique, cell re-selection is performed.

9. A method performed by a user equipment (UE), comprising:
identifying cells that implement at least one network energy saving technique; and
selecting or re-selecting a cell that implements at least one network energy saving technique and that fulfills a predetermined criterion based at least in part on cell selection or re-selection being performed.

10. A base unit, comprising:
at least one memory; and
at least one processor coupled with the at least one memory and configured to cause the base unit to indicate whether the base unit implements at least one energy saving technique.

11. The base unit of claim 10, wherein, the at least one processor is configured to cause the base unit to indicate whether each of neighboring base units is a base unit that implements at least one network energy saving technique.

12. The base unit of claim 10, wherein, the at least one processor is configured to cause the base unit to indicate whether the base unit is a base unit that supports at least one energy saving technique in sleep state or in non-sleep state.

13. The base unit of claim 12, wherein, the at least one processor is configured to cause the base unit to indicate whether each of neighboring base units is a base unit that supports at least one energy saving technique in sleep state or in non-sleep state.

14. The base unit of claim 10, wherein, the at least one processor is configured to cause the base unit to transmit system information broadcast or dedicated signaling to indicate whether the base unit is the base unit that supports at least one energy saving technique.

15. A processor for wireless communication, comprising:
at least one controller coupled with at least one memory and configured to cause the processor to:
identify cells that implement at least one network energy saving technique; and
select or re-select a cell that implements at least one network energy saving technique and that fulfills a predetermined criterion based at least in part on cell selection or re-selection being performed.

16. The processor of claim 15, wherein, the at least one controller is configured to cause the processor to receive system information broadcast or dedicated signaling to identify cells that implement at least one network energy saving technique.

17. The processor of claim 15, wherein, the cell that implements at least one network energy saving technique has precedence over a legacy cell that does not implement at least one network energy saving technique in cell selection or re-selection.

18. The processor of claim 15, wherein, the at least one controller is configured to cause the processor to identify whether a cell that implements at least one network energy saving technique is in sleep state or in non-sleep state.

19. The processor of claim 18, wherein, the at least one controller is configured to cause the processor to receive system information broadcast or dedicated signaling to identify the state of the cell that implements at least one network energy saving technique.

20. The processor of claim 18, wherein, a cell that implements at least one network energy saving technique in sleep state has precedence over a cell that implements at least one network energy saving technique in non-sleep state in cell selection or re-selection.
